(19) United States
(12) Patent Application Publication
(10) Pub. No.: US 2026/0175429 A1
(43) Pub. Date: Jun. 25, 2026

(54) ROBOT NAVIGATION METHOD, ELECTRONIC DEVICE, AND COMPUTER-READABLE STORAGE MEDIUM

(71) Applicant: UBTECH ROBOTICS CORP LTD, Shenzhen (CN)

(72) Inventors: YU TANG, Shenzhen (CN); Simin Zhang, Shenzhen (CN)

(21) Appl. No.: 19/315,495

(22) Filed: Aug. 30, 2025

(30) Foreign Application Priority Data
Dec. 25, 2024 (CN) 202411948370.8

(51) Int. Cl. B25J 9/16; B25J 13/08

(52) U.S. Cl. CPC B25J 9/1666; B25J 9/1694; B25J 13/089

(57) ABSTRACT

A robot navigation method, an electronic device, and a computer-readable storage medium are provided. The method includes: obtaining an initial map marked with an area type of each of obstacle areas in the initial map; obtaining, during navigating the robot according to the initial map, a real-time ultra-wideband localization position; determining, based on the real-time ultra-wideband localization position, a target obstacle area among the obstacle areas where the robot is located; and controlling, based on a navigation parameter corresponding to a target area type of the target obstacle area, the robot to move. In this manner, the safety of the robot can be improved.

### CROSS REFERENCE TO RELATED APPLICATIONS

The present disclosure claims priority to Chinese Patent Application No. 202411948370.8, filed December 25, 2024, which is hereby incorporated by reference herein as if set forth in its entirety.

### TECHNICAL FIELD

The present disclosure relates to robotics technology, and particularly to a robot navigation method, an electronic device, and a computer-readable storage medium.

### BACKGROUND

Robots are intelligent machines that can work semi-autonomously or fully autonomously, and can automatically move to the work area for performing tasks through navigation. Indoor mobile robots will encounter many safety problems during navigation and movement, for example, due to the limitations of their motion performances, it is necessary to avoid scenes such as escalators, ladders, or elevators. In relevant technologies, image sensors or depth sensors will be used to identify protective areas, or geomagnetic devices will be added to the protective areas to avoid obstacles through magnetic induction. However, these solutions require adding other sensors or transforming the environment, which are costly and not good in detection accuracy or response speed, and are difficult to meet the motion safety requirements of the robots.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a robot navigation method according to an embodiment of the present disclosure.

FIG. 2 is a schematic diagram of an interface for editing maps according to an embodiment of the present disclosure.

FIG. 3 is a schematic diagram of expansion according to an embodiment of the present disclosure.

FIG. 4 is a schematic block diagram of the structure of a robot navigation apparatus according to an embodiment of the present disclosure.

FIG. 5 is a schematic block diagram of an electronic device according to an embodiment of the present disclosure.

### DETAILED DESCRIPTION

In order to make the objects of the present disclosure more clear, the technical solutions and advantages will be clearly understand. The present disclosure will be further described in detail below with reference to the drawings and the embodiments. It should be noted that the specific embodiments described herein are only intended for the explanation of the present disclosure, and are not limited to the present disclosure. Based on the embodiments of the present disclosure, all other embodiments obtained by those skilled in the art without creative work are within the scope of the present disclosure.

It is to be understood that, when used in the description and the appended claims of the present disclosure, the terms "including" and "comprising" indicate the described features, integers, steps, operations, elements and/or components, but do not preclude the presence or addition of one or a plurality of other features, integers, steps, operations, elements, components and/or combinations thereof.

In the specification and the claims of the present disclosure, the terms "first", "second", "third", and the like in the descriptions are only used for distinguishing, and cannot be understood as indicating or implying relative importance.

References such as "one embodiment" and "some embodiments" in the specification of the present disclosure mean that the particular features, structures or characteristics described in combination with the embodiment(s) are included in one or more embodiments of the present disclosure. Therefore, the sentences "in one embodiment", "in some embodiments", "in other embodiments", "in other embodiments", "in other embodiments" and the like in different places of this specification do not necessarily all refer to the same embodiment, but mean "one or more but not all embodiments" unless specifically emphasized otherwise specifically, "including" includes", "comprising", "having" and their variations mean "including to" unless specifically emphasized otherwise.

Robots are intelligent machines that can work semi-autonomously or fully autonomously, and can automatically move to the work area for performing tasks through navigation. Indoor mobile robots will encounter many safety problems during navigation and movement, for example, due to the limitations of their motion performances, it is necessary to avoid scenes such as escalators, ladders, or elevators. In relevant technologies, image sensors or depth sensors will be used to identify protective areas, or geomagnetic devices will be added to the protective areas to avoid obstacles through magnetic induction. However, these solutions require adding other sensors or transforming the environment, which are costly and not good in detection accuracy or response speed, and are difficult to meet the motion safety requirements of the robots.

In view of this, in the present disclosure, a robot navigation method is provided, which can use ultra-wideband localization technology to set corresponding navigation parameters for navigating a robot in different obstacle areas in the motion scenario of the robot so as to adapt to the navigation requirements of the corresponding obstacle area, thereby ensuring the motion safety of the robot.

Specific embodiments are provided to illustrate the technical solutions of the present disclosure as follows.

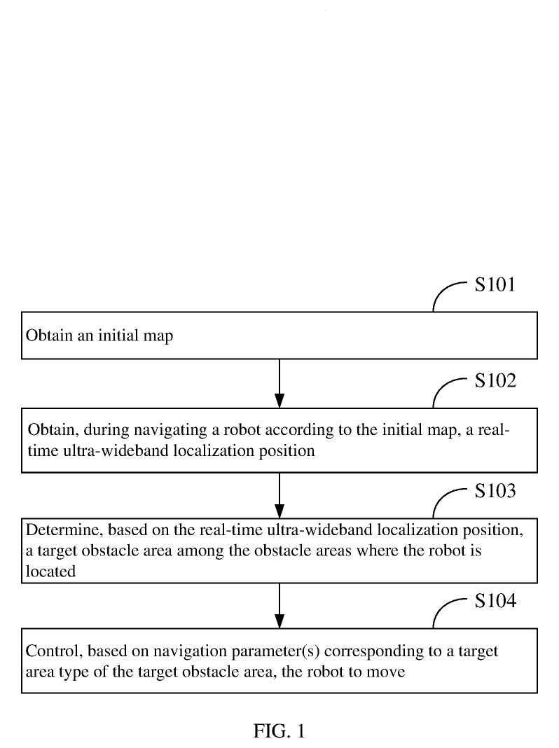

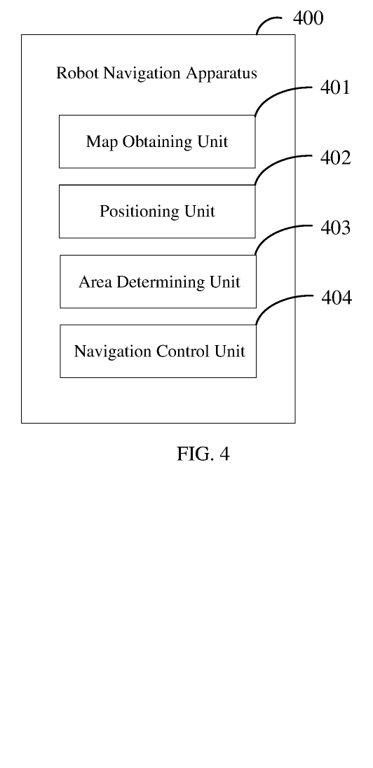

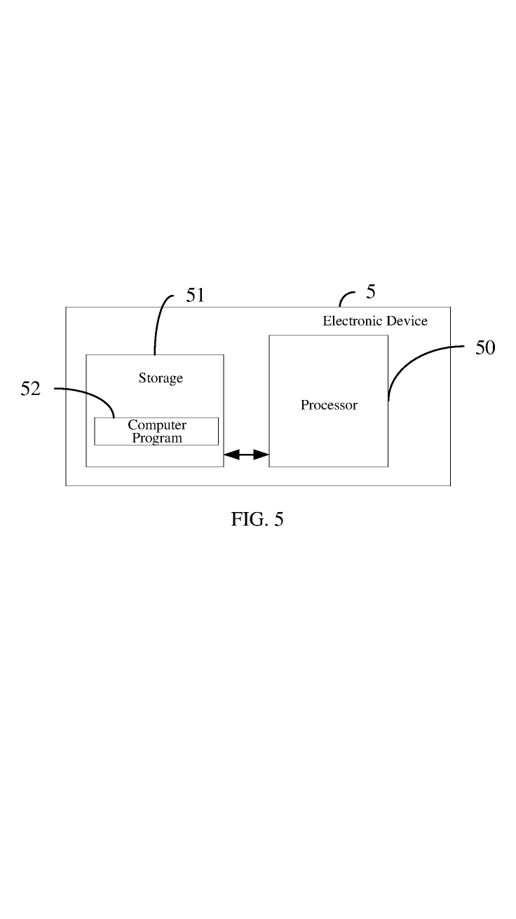

FIG. 1 is a flow chart of a robot navigation method according to an embodiment of the present disclosure. In this embodiment, a navigation method is applied to (a processor of) a robot (e.g., a humanoid robot or a sweeping robot) having a sensor (e.g., a position sensor). In other embodiments, the method may be implemented through a robot navigation apparatus as shown in FIG. 4 or an electronic device as shown in FIG. 5. As shown in FIG. 1, in this embodiment, the navigation method may include the following steps.

S101: obtaining an initial map.

In which, the initial map is a map for navigating the robot. The initial map may be a raster map, a vector map, or other electronic map. The initial map is marked with an area type of each of obstacle areas in the initial map. The area type can reflect the type of obstacle(s) in the area, while reflecting the strateg(ies) that the robot needs to adopt when facing the area.

S102: obtaining, during navigating the robot according to the initial map, a real-time ultra-wideband localization position.

In this embodiment, ultra-wideband (UWB) localization is used, so during navigating the robot according to the initial map, the robot may use a wireless positioning sensor to interact with an UWB base station, thereby determining the real-time ultra-wideband localization position. The real-time ultra-wideband localization position refers to real-time positional information of the robot that is obtained by the robot through ultra-wideband localization. In other embodiments, other localization mechanism may be used. For example, if Lidar localization is used, a real-time Lidar localization position may be obtained

S103: determining, based on the real-time ultra-wideband localization position, a target obstacle area among the obstacle areas where the robot is located.

In this embodiment, according to the real-time ultra-wideband localization position, the target obstacle area in which the robot is located may be determined among the obstacle areas in the initial map.

S104: controlling, based on navigation parameter(s) corresponding to a target area type of the target obstacle area, the robot to move.

In which, the navigation parameter(s) are for directing the robot to perform obstacle avoidance during navigation. For each obstacle area in the initial map, the navigation parameter(s) corresponding to each area type may be set in advance. After determining the target obstacle area in which the robot is located, it may control, based on the navigation parameter(s) corresponding to the target area type of the target obstacle area, the robot to move, so that the robot performs obstacle avoidance on the target obstacle area according to the navigation parameter(s).

In this embodiment, it may obtain the real-time ultra-wideband localization position during navigating the robot according to the initial map, and control the robot to move according to the navigation parameter(s) corresponding to the target area type of the target obstacle area where the robot is located. It may use ultra-wideband localization technology to set corresponding navigation parameters for navigating a robot in different obstacle areas in the motion scenario of the robot so as to adapt to the navigation requirements of the corresponding obstacle area, thereby ensuring the motion safety of the robot.

In some embodiments, the obtaining the initial map may include: obtaining sensing data frame during moving the robot, and obtaining an absolute position corresponding to the sensing data frame, and generating a sensing data frame library based on the obtained sensing data frame and the absolute position. Based on the absolute position corresponding to the sensing data frame currently obtained by the robot and a preset distance threshold, it searches the absolute position matching the current absolute position from the sensing data frame library, and the sensing data frame corresponding to the matched absolute position. Then it matches the searched sensing data frame with the currently obtained sensing data frame, and performs loopback optimization and initial map construction based on the matching result.

In which, the sensing data frame may include a scene image, a distance between an obstacle in the scene and the robot, the pose (i.e., the position and the posture) of the robot, and the like. The absolute position may be determined by the robot in combination with auxiliary positioning equipment. For example, it may install a positioning base station in the scene where the robot is located, and transmit a detection signal through the positioning base station. Based on the received positioning signal, the robot may determine the distance between the robot and the positioning base station. Based on two or more than three determined distances, and a preset position of the positioning base station, it may determine the absolute position of the robot. In which, the positioning base station may be an ultra-wideband base station.

When one or more sensing data frames are searched based on absolute positions, the one or more sensing data frames may be matched with the currently obtained sensing data frame, that is, the similarity between the searched sensing data frame and the currently obtained sensing data frame. If the similarity is larger than a predetermined similarity threshold, the sensing data frame and the absolute position may be selected to optimize a movement trajectory of the robot. For example, it may determine a loopback point of the robot based on the absolute position, and determine posture information of the robot at the loopback point based on the sensing data frame. Based on the determined loopback point and the posture information, it may adjust the movement trajectory of the robot, and adjust posture change information of the robot during moving. The initial map may be constructed based on the adjusted trajectory and posture change information.

In some embodiments, after obtaining the initial map, it may be marked according to the editing operations of a user.

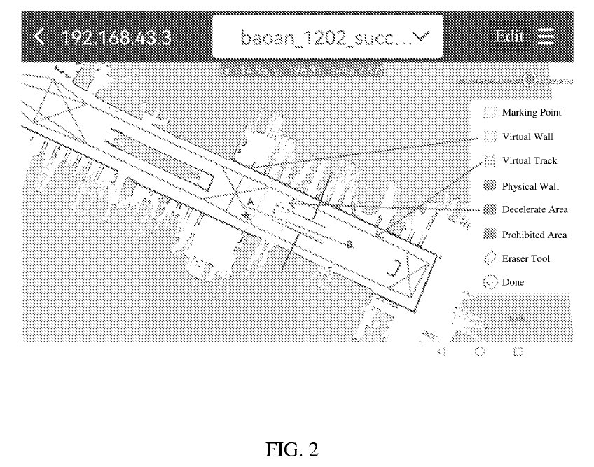

FIG. 2 is a schematic diagram of an interface for editing maps according to an embodiment of the present disclosure. Specifically, as shown in FIG. 2, the user may delineate obstacle areas and set area types such as marking points, virtual walls, virtual tracks, physical walls, decelerate areas, and prohibited areas through the initial map displayed on an editing interface (e.g., a GUI on a screen).

In some embodiments, the obtaining, during navigating the robot according to the initial map, the real-time ultra-wideband localization position may include: obtaining a particle set for positioning the robot; obtaining a position after updated of each of particles in the particle set by updating the position of the particle based on a preset motion model; obtaining laser measurement data and ultra-wideband measurement data; calculating, based on the laser measurement data, the ultra-wideband measurement data, and the position after updated of each of the particles, a matching probability of the particle; and obtaining the real-time ultra-wideband localization position by positioning the robot based on the matching probability of each of the particles.

Specifically, "particle filtering" refers to the process of approximately representing a probability density function by finding a set of random samples propagated in a state space and replacing integral operation with sample mean so as to obtain a minimum variance estimation of a system state. Since these samples are vividly called "particles", the process is called "particle filtering". The particle set is composed of a preset number of particles. In the initial state, the position of each particle in the particle set may be randomly selected from the map. In the subsequent process, the particle set obtained at any moment is the updated particle set obtained after resampling the particle set obtained at the previous moment.

The position of each particle at the current moment may be estimated using the position of the particle at the previous moment based on the preset motion model. When calculating the probability of the particle, the laser measurement data and the ultra-wideband measurement data may be taken into account to constrain most of the particles to be near the ultra-wideband localization position, thereby ensuring that the particles near the correct position will never disappear. When the characteristics become rich, the probability of each particle may be accurately calculated through the laser measurement data to obtain the real-time ultra-wideband localization position with high precision.

In some embodiments, the determining, based on the real-time ultra-wideband localization position, the target obstacle area among the obstacle areas where the robot is located may include: obtaining a localization position of the robot that is collected by a sensor of the robot; and determining the target obstacle area where the robot is located at a dangerous area in response to any position between the localization position of the robot and the real-time ultra-wideband localization position being located at the dangerous area.

In which, the sensor may be an image sensor, a lidar, or the like other than the above-mentioned wireless positioning sensor. Based on sensor data collected by the sensor, the localization position of the robot may be determined. If the on-site scene of the robot changes frequently or is large, the location of the robot is easily lost, then it may determine the target obstacle area where the robot is located at a dangerous area in response to any position between the localization position of the robot and the real-time ultra-wideband localization position being located at the dangerous area.

The dangerous area is a specific area in each obstacle area, such as an elevator area, ladder area, or the like. If any position between the localization position of the robot and the real-time ultra-wideband localization position is located at the dangerous area, it may determine that the target obstacle area where the robot is located at a dangerous area. Correspondingly, if the localization position of the robot and the real-time ultra-wideband localization position are both in a non-dangerous area, it may determine that the target obstacle area where the robot is located is the non-dangerous area. In this manner, if the localization position of the robot is lost, or if the localization position of the robot is incorrect when positioning in a similar scenario, the obstacle avoidance for the dangerous area may be performed using the real-time ultra-wideband localization position.

In some embodiments, the navigation parameter corresponding to the target area type of the target obstacle area may include an obstacle avoidance threshold. According to the navigation parameter corresponding to the target area type of the target obstacle area, the controlling, based on the navigation parameter corresponding to the target area type of the target obstacle area, the robot to move may include: keeping, during controlling the robot to move, a first distance to be larger than the obstacle avoidance threshold

In which, the first distance is the distance between the robot and the target obstacle area. The obstacle avoidance threshold is the minimal distance with respect to the obstacle area.

In some embodiments, the obstacle avoidance thresholds corresponding to the different area types of the different obstacle areas may be different. In order to achieve a better obstacle avoidance effect in a specific area, a larger obstacle avoidance threshold may be set. Specifically, if the robot is located at the non-dangerous area, a first obstacle avoidance threshold may be set. If the robot is located at the dangerous area, a second obstacle avoidance threshold may be set. The second obstacle avoidance threshold is larger than the first obstacle avoidance threshold, which meets the demand for avoiding dangerous areas such as elevators, thereby ensuring the safety of the motion of the robot.

In other embodiments, the navigation parameter corresponding to the target area type of the target obstacle area may include an expansion radius. The controlling, based on the navigation parameter corresponding to the target area type of the target obstacle area, the robot to move may include: obtaining a cost map by expanding the target obstacle area according to the expansion radius; and controlling, according the cost map, the robot to move.

In some embodiments, the expansion radiuses corresponding to the different area types of the different obstacle areas may be different. In order to achieve a better obstacle avoidance effect in a specific area, the expansion radius of the local cost map may be expanded. Specifically, if the robot is located at the non-dangerous area, the target obstacle area may be expanded according to the first expansion radius. If the robot is located at the dangerous area, the target obstacle area may be expanded according to the second expansion radius.

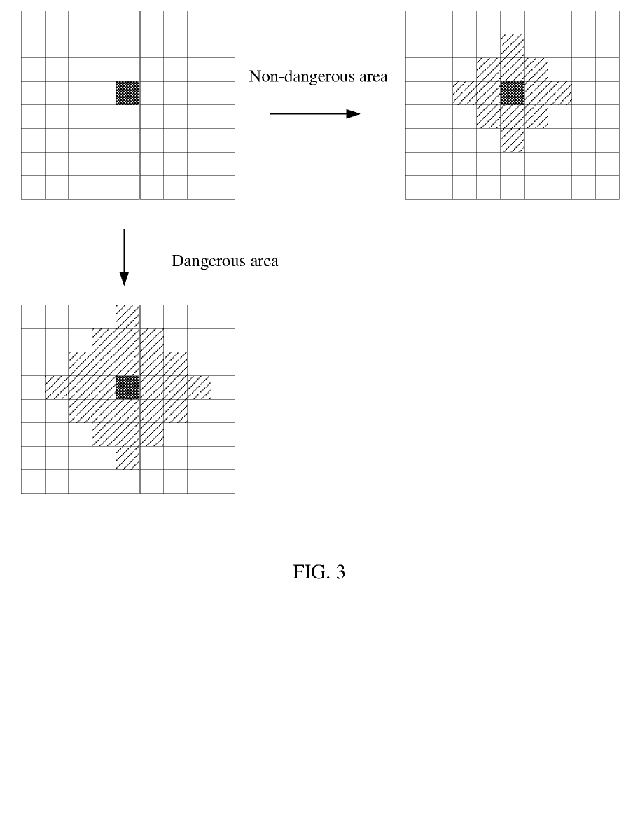

FIG. 3 is a schematic diagram of expansion according to an embodiment of the present disclosure. As shown in FIG. 3, if the black square is the non-dangerous area, it may expand using the first expansion radius; if the black square is the dangerous area, it may expand using the second expansion radius. The twill square represents the expanded area. It can be seen that the area of the dangerous area becomes larger after expansion so as to achieve the need to avoid dangerous areas such as elevators, thereby ensuring the safety of the motion of the robot.

It should be noted that for the sake of brief description, each of the foregoing method embodiments are all expressed as a series of action combinations. However, those skilled in the art should know that present disclosure is not limited by the described action sequence, because certain steps may be carried out in other orders according to the present disclosure.

FIG. 4 is a schematic block diagram of the structure of a robot navigation apparatus according to an embodiment of the present disclosure. As shown in FIG. 4, in this embodiment, a robot navigation apparatus 400 may be installed on an electronic device. For example, if the electronic device is the above-mentioned robot, the robot navigation apparatus 400 may be a controller of the robot. Specifically, the robot navigation apparatus 400 may include:

a map obtaining unit 401 configured to obtain an initial map marked with an area type of each of obstacle areas in the initial map;

a positioning unit 402 configured to obtain, during navigating the robot according to the initial map, a real-time ultra-wideband localization position;

an area determining unit 403 configured to determine, based on the real-time ultra-wideband localization position, a target obstacle area among the obstacle areas where the robot is located; and

a navigation control unit 404 configured to control, based on a navigation parameter corresponding to a target area type of the target obstacle area, the robot to move.

In some embodiments, the navigation parameter corresponding to the target area type of the target obstacle area may include an obstacle avoidance threshold, and the navigation control unit 404 may be configured to keep, during controlling the robot to move, a first distance between the robot and the target obstacle area to be larger than the obstacle avoidance threshold.

In some embodiments, the obstacle avoidance thresholds corresponding to the different area types of the different obstacle areas may be different.

In some embodiments, the navigation parameter corresponding to the target area type of the target obstacle area may include an expansion radius, and the navigation control unit 404 may be configured to obtain a cost map by expanding the target obstacle area according to the expansion radius; and control, according the cost map, the robot to move.

In some embodiments, the expansion radiuses corresponding to the different area types of the different obstacle areas may be different.

In some embodiments, the positioning unit 402 may be configured to obtain a particle set for positioning the robot; obtain a position after updated of each of particles in the particle set by updating the position of the particle based on a preset motion model; obtain laser measurement data and ultra-wideband measurement data; calculate, based on the laser measurement data, the ultra-wideband measurement data, and the position after updated of each of the particles, a matching probability of the particle; and obtain the real-time ultra-wideband localization position by positioning the robot based on the matching probability of each of the particles.

In some embodiments, the area determining unit 403 may be configured to obtain a localization position of the robot that is collected by a sensor of the robot; and determine the target obstacle area where the robot is located at a dangerous area in response to any position between the localization position of the robot and the real-time ultra-wideband localization position being located at the dangerous area.

It should be noted that, for the convenience and simplicity of description, the specific operation process of the robot navigation apparatus 400 may be referenced to the corresponding process of the methods in FIG. 1-FIG. 3, which will not be described herein.

FIG. 5 is a schematic block diagram of an electronic device 5 according to an embodiment of the present disclosure. As shown in FIG. 5, in this embodiment, the electronic device 5 may include a processor 50, a storage 51, and a computer program 52 stored in the storage 51 and executed on the processor 50 of the robot, for example, a robot navigation program. The electronic device 5 may be a controller of the above-mentioned robot. When the processor 50 executes the computer program 52, the steps in each of the above-mentioned embodiments of the robot navigation method, for example, steps S101-S104 shown in FIG. 1 are implemented, or the functions of each module /unit in each of the above-mentioned apparatus embodiments, for example, the map obtaining unit 401, the positioning unit 402, the area determining unit 403, and the navigation control unit 404 shown in FIG. 4 are implemented.

The computer program 52 may be divided into one or more modules / units, and the one or more modules / units are stored in the storage 51 and executed by the processor 50 to realize the present disclosure. The one or more modules / units may be a series of computer program instruction sections capable of performing a specific function, and the instruction sections are for describing the execution process of the computer program 52 in the electronic device 5.

For example, the computer program may be divided into a map obtaining unit, a positioning unit, an area determining unit, and a navigation control unit. The specific functions of each unit are as follows: the map obtaining unit is configured to obtain an initial map marked with an area type of each of obstacle areas in the initial map; the positioning unit is configured to obtain, during navigating the robot according to the initial map, a real-time ultra-wideband localization position; the area determining unit is configured to determine, based on the real-time ultra-wideband localization position, a target obstacle area among the obstacle areas where the robot is located; and the navigation control unit is configured to control, based on a navigation parameter corresponding to a target area type of the target obstacle area, the robot to move.

The electronic device 5 may include, but is not limited to, the processor 50 and the storage 51. It can be understood by those skilled in the art that FIG. 5 is merely an example of the electronic device 5 and does not constitute a limitation on the electronic device 5, and may include more or fewer components than those shown in the figure, or a combination of some components or different components. For example, the electronic device 5 may further include an input / output device, a network access device, a bus, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the electronic device 5, for example, a hard disk or a memory of the electronic device 5. The storage 51 may also be an external storage device of the electronic device 5, for example, a plug-in hard disk, a smart media card (SMC), a secure digital (SD) card, flash card, and the like, which is equipped on the electronic device 5. Furthermore, the storage 51 may further include both an internal storage unit and an external storage device, of the electronic device 5. The storage 51 is configured to store the computer program 52 and other programs and data required by the electronic device 5. The storage 51 may also be used to temporarily store data that has been or will be output.

It should be noted that, for the convenience and simplicity of description, the structure of the above-mentioned electronic device may also refer to the specific descriptions in the method embodiments that are about structures, which will not be described herein.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device) / electronic device and method may be implemented in other manners. For example, the above-mentioned apparatus / electronic device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each embodiment of the present disclosure may be integrated into one processing unit, or each unit may exist physically only, or two or more units may be integrated in one unit. The above-mentioned integrated unit may be implemented in the form of hardware or in the form of software functional unit.

When the integrated module / unit is implemented in the form of a software functional unit and is sold or used as an independent product, the integrated module / unit may be stored in a non-transitory computer readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer readable storage medium, which may implement the steps of each of the above-mentioned method embodiments when executed by a processor. In which, the computer program includes computer program codes which may be the form of source codes, object codes, executable files, certain intermediate, and the like. The computer readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above--mentioned embodiments are merely intended for describing but not for limiting the technical schemes of the present disclosure. Although the present disclosure is described in detail with reference to the foregoing-mentioned embodiments, it should be noted by those skilled in the art that, the technical schemes in each of the foregoing-mentioned embodiments may still be modified, or some of the technical features may be equivalently replaced. These modifications or replacements do not make the essence of the corresponding technical schemes depart from the spirit and scope of the technical schemes of each of the embodiments of the present disclosure, and should be included within the scope of the present disclosure.

What is claimed is:

1. A method for navigating a robot, comprising:
obtaining an initial map marked with an area type of each of obstacle areas in the initial map;
obtaining, during navigating the robot according to the initial map, a real-time ultra-wideband localization position through a wireless positioning sensor;
obtaining a localization position of the robot that is collected by another positioning sensor of the robot;
determining a target obstacle area among the obstacle areas where the robot is located at a dangerous area in response to any position between the localization position of the robot and the real-time ultra-wideband localization position being located at the dangerous area; and
controlling, based on a navigation parameter corresponding to the area type of the target obstacle area, the robot to move.

2. The method of claim 1, wherein the navigation parameter corresponding to the area type of the target obstacle area includes an obstacle avoidance threshold; and
wherein controlling, based on the navigation parameter corresponding to the area type of the target obstacle area, the robot to move comprises:
keeping, during controlling the robot to move, a first distance between the robot and the target obstacle area to be larger than the obstacle avoidance threshold.

3. The method of claim 2, wherein the obstacle avoidance thresholds corresponding to the different area types of the different obstacle areas are different.

4. The method of claim 1, wherein the navigation parameter corresponding to the area type of the target obstacle area includes an expansion radius; and
wherein controlling, based on the navigation parameter corresponding to the area type of the target obstacle area, the robot to move comprises:
obtaining a cost map by expanding the target obstacle area according to the expansion radius; and
controlling, according the cost map, the robot to move.

5. The method of claim 4, wherein the expansion radiuses corresponding to the different area types of the different obstacle areas are different.

6. The method of claim 1, wherein obtaining, during navigating the robot according to the initial map, the real-time localization position comprises:
obtaining a particle set for positioning the robot;
obtaining a position after updated of each of particles in the particle set by updating the position of the particle based on a preset motion model;
obtaining laser measurement data and ultra-wideband measurement data;
calculating, based on the laser measurement data, the ultra-wideband measurement data, and the position after updated of each of the particles, a matching probability of the particle; and
obtaining the real-time localization position by positioning the robot based on the matching probability of each of the particles.

7. An electronic device, comprising:
a processor;
a memory coupled to the processor; and
one or more computer programs stored in the memory and executable on the processor;
wherein, the one or more computer programs comprise:
instructions for obtaining an initial map marked with an area type of each of obstacle areas in the initial map;
instructions for obtaining, during navigating a robot according to the initial map, a real-time ultra-wideband localization position through a wireless positioning sensor;
instructions for obtaining a localization position of the robot that is collected by another positioning sensor of the robot;
instructions for determining a target obstacle area among the obstacle areas where the robot is located at a dangerous area in response to any position between the localization position of the robot and the real-time ultra-wideband localization position being located at the dangerous area; and
instructions for controlling, based on a navigation parameter corresponding to the area type of the target obstacle area, the robot to move.

8. The electronic device of claim 7, wherein the navigation parameter corresponding to the area type of the target obstacle area includes an obstacle avoidance threshold; and
wherein the instructions for controlling, based on the navigation parameter corresponding to the area type of the target obstacle area, the robot to move comprise:
instructions for keeping, during controlling the robot to move, a first distance between the robot and the target obstacle area to be larger than the obstacle avoidance threshold.

9. The electronic device of claim 8, wherein the obstacle avoidance thresholds corresponding to the different area types of the different obstacle areas are different.

10. The electronic device of claim 7, wherein the navigation parameter corresponding to the area type of the target obstacle area includes an expansion radius; and
wherein the instructions for controlling, based on the navigation parameter corresponding to the area type of the target obstacle area, the robot to move comprise:
instructions for obtaining a cost map by expanding the target obstacle area according to the expansion radius; and
instructions for controlling, according the cost map, the robot to move.

11. The electronic device of claim 10, wherein the expansion radiuses corresponding to the different area types of the different obstacle areas are different.

12. The electronic device of claim 7, wherein the instructions for obtaining, during navigating the robot according to the initial map, the real-time localization position comprise:
instructions for obtaining a particle set for positioning the robot;
instructions for obtaining a position after updated of each of particles in the particle set by updating the position of the particle based on a preset motion model;
instructions for obtaining laser measurement data and ultra-wideband measurement data;
instructions for calculating, based on the laser measurement data, the ultra-wideband measurement data, and the position after updated of each of the particles, a matching probability of the particle; and
instructions for obtaining the real-time localization position by positioning the robot based on the matching probability of each of the particles.

13. A non-transitory computer-readable storage medium for storing one or more computer programs, wherein the one or more computer programs comprise:
instructions for obtaining an initial map marked with an area type of each of obstacle areas in the initial map;
instructions for obtaining, during navigating a robot according to the initial map, a real-time ultra-wideband localization position through a wireless positioning sensor;
instructions for obtaining a localization position of the robot that is collected by another positioning sensor of the robot;
instructions for determining a target obstacle area among the obstacle areas where the robot is located at a dangerous area in response to any position between the localization position of the robot and the real-time ultra-wideband localization position being located at the dangerous area; and
instructions for controlling, based on a navigation parameter corresponding to the area type of the target obstacle area, the robot to move.

14. The storage medium of claim 13, wherein the navigation parameter corresponding to the area type of the target obstacle area includes an obstacle avoidance threshold; and
wherein the instructions for controlling, based on the navigation parameter corresponding to the area type of the target obstacle area, the robot to move comprise:
instructions for keeping, during controlling the robot to move, a first distance between the robot and the target obstacle area to be larger than the obstacle avoidance threshold.

15. The storage medium of claim 14, wherein the obstacle avoidance thresholds corresponding to the different area types of the different obstacle areas are different.

16. The storage medium of claim 13, wherein the navigation parameter corresponding to the area type of the target obstacle area includes an expansion radius; and
wherein the instructions for controlling, based on the navigation parameter corresponding to the area type of the target obstacle area, the robot to move comprise:
instructions for obtaining a cost map by expanding the target obstacle area according to the expansion radius; and
instructions for controlling, according the cost map, the robot to move.

17. The storage medium of claim 16, wherein the expansion radiuses corresponding to the different area types of the different obstacle areas are different.

18. The storage medium of claim 13, wherein the instructions for obtaining, during navigating the robot according to the initial map, the real-time localization position comprise:
instructions for obtaining a particle set for positioning the robot;
instructions for obtaining a position after updated of each of particles in the particle set by updating the position of the particle based on a preset motion model;
instructions for obtaining laser measurement data and ultra-wideband measurement data;
instructions for calculating, based on the laser measurement data, the ultra-wideband measurement data, and the position after updated of each of the particles, a matching probability of the particle; and
instructions for obtaining the real-time ultra-wideband localization position by positioning the robot based on the matching probability of each of the particles.
